(19) United States
(12) Patent Application Publication
(10) Pub. No.: US 2026/0060307 A1
(43) Pub. Date: Mar. 5, 2026

(54) AEROSOL GENERATING DEVICE AND TEMPERATURE CONTROL METHOD THEREFOR

(71) Applicant: SMOORE INTERNATIONAL HOLDINGS LIMITED, George Town (KY)

(72) Inventors: Hengheng DOU, Shenzhen (CN); Xingfu ZHANG, Shenzhen (CN); Lei MA, Shenzhen (CN)

(21) Appl. No.: 19/383,612

(22) Filed: Nov. 8, 2025

Related U.S. Application Data
(63) Continuation of application No. PCT/CN2024/091473, filed on May 7, 2024.

(30) Foreign Application Priority Data
May 9, 2023 (CN) 202310525504.4

(51) Int. Cl. A24F 40/46; A24F 40/42; A24F 40/53; A24F 40/57

(52) U.S. Cl. CPC A24F 40/46; A24F 40/42; A24F 40/53; A24F 40/57

(57) ABSTRACT

An aerosol generating device includes a heating element for generating infrared light; a housing having a housing wall that allows the infrared light to pass through, the heating element and the housing wall being at least partially spaced apart; a first temperature obtaining unit that obtains the housing wall temperature of the housing wall; a second temperature obtaining unit that obtains the heating element temperature of the heating element; and a control unit that: outputs a target control temperature based on a preset temperature and the housing wall temperature, processes the heating element temperature and the target control temperature using a preset algorithm, and adjusts power supplying of the heating element.

### CROSS-REFERENCE TO PRIOR APPLICATION

This application is a continuation of International Patent Application No. PCT/CN2024/091473, filed on May 7, 2024, which claims priority to Chinese Patent Application No. 202310525504.4, filed on May 9, 2023. The entire disclosure of both applications is hereby incorporated by reference herein.

### FIELD

The present disclosure relates to the field of heat not burn heating, and in particular to, an aerosol generating device and a temperature control method therefor.

### BACKGROUND

An aerosol generating device is a device that heats an aerosol generating substrate to generate an aerosol. The existing aerosol generating device uses a conduction manner to heat the aerosol generating substrate, namely, a heating element transfers heat to the aerosol generating substrate in the conduction manner after being heated. Based on the characteristics of the conduction heating manner, a difference between temperatures of aerosol generating substrates away from the heating element at different distances is large, and a conduction process has a delay, so that problems of incomplete heating and a non-uniform heating occur in different heating stages.

### SUMMARY

In an embodiment, the present invention provides an aerosol generating device, comprising: a heating element configured to generate infrared light; a housing having a housing wall configured to allow the infrared light to pass through, the heating element and the housing wall being at least partially spaced apart; a first temperature obtaining unit configured to obtain the housing wall temperature of the housing wall; a second temperature obtaining unit configured to obtain the heating element temperature of the heating element; and a control unit configured to: output a target control temperature based on a preset temperature and the housing wall temperature, process the heating element temperature and the target control temperature using a preset algorithm, and adjust power supplying of the heating element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic block diagram of an aerosol generating device according to an embodiment of the present disclosure;

FIG. 2 is a schematic diagram of a preset time-temperature relationship according to an embodiment of the present disclosure;

FIG. 3 is a schematic diagram of a preset time-temperature relationship according to an embodiment of the present disclosure;

FIG. 4 is a schematic structural diagram of a heating element in an aerosol generating device embodiment according to the present disclosure;

FIG. 5a and FIG. 5b are schematic structural diagrams of a heating element in another aerosol generating device embodiment according to the present disclosure; and

FIG. 6 is flowchart of a temperature control method for an aerosol generating device according to an embodiment of the present disclosure.

### DETAILED DESCRIPTION

In an embodiment, the present invention provides an aerosol generating device and a temperature control method therefor.

In an embodiment, the present invention provides an aerosol generating device, including:
heating element; and
a housing. The heating element and the housing wall of the housing are at least partially spaced apart. The heating element is configured to generate infrared light, and the housing wall of the housing allows the infrared light to pass through.

The device further includes:
a first temperature obtaining unit, configured to obtain the housing wall temperature of the housing wall;
a second temperature obtaining unit, configured to obtain the heating element temperature of the heating element; and
a control unit, configured to: output a target control temperature based on a preset temperature and the housing wall temperature, process the heating element temperature and the target control temperature by using a preset algorithm, and adjust power supplying of the heating element.

Further, in the aerosol generating device of the present disclosure, the control unit is configured to: output a first target temperature when the housing wall temperature is less than the preset temperature and output a second target temperature when the housing wall temperature is not less than the preset temperature. The first target temperature is greater than the second target temperature.

The control unit processes the heating element temperature and the target control temperature by using a proportion-integration-differentiation (PID) control algorithm and adjusts the power supplying of the heating element; and the target control temperature includes the first target temperature and the second target temperature.

Further, in the aerosol generating device of the present disclosure, the first target temperature is a temperature at which the heating element is capable of radiating the infrared light and the wavelength of the infrared light is suitable for heating an aerosol generating substrate.

Further, in the aerosol generating device of the present disclosure, the second target temperature is not greater than the natural temperature of the heating element without power supplying.

Further, in the aerosol generating device of the present disclosure, the second target temperature ranges from 0° C. to 30° C.

Further, in the aerosol generating device of the present disclosure, the control unit obtains a preset temperature corresponding to current time based on a preset time-temperature relationship; and the preset time-temperature relationship is a correspondence relationship between time and a preset temperature.

Further, in the aerosol generating device of the present disclosure, the preset time-temperature relationship is divided into at least two time-temperature relationship zones in chronological order, and the temperature of the preset time-temperature relationship decreases in sequence along with each time-temperature relationship zone.

Each time-temperature relationship zone corresponds to one first target temperature; and the first target temperature decreases in sequence along with each time-temperature relationship zone.

Further, in the aerosol generating device of the present disclosure, the preset time-temperature relationship includes three time-temperature relationship zones: a first time-temperature relationship zone, a second time-temperature relationship zone, and a third time-temperature relationship zone.

The preset temperature corresponding to the first time-temperature relationship zone is greater than the preset temperature corresponding to the second time-temperature relationship zone; and the preset temperature corresponding to the second time-temperature relationship zone is greater than the preset temperature corresponding to the third time-temperature relationship zone.

Further, in the aerosol generating device of the present disclosure, the preset temperature corresponding to the first time-temperature relationship zone ranges from 360° C. to 420° C.;
the preset temperature corresponding to the second time-temperature relationship zone ranges from 250° C. to 360° C.; and
the preset temperature corresponding to the third time-temperature relationship zone ranges from 230° C. to 290° C.

Further, in the aerosol generating device of the present disclosure, the preset time-temperature relationship includes three time-temperature relationship zones: a first time-temperature relationship zone, a second time-temperature relationship zone, and a third time-temperature relationship zone.

The first target temperature corresponding to the first time-temperature relationship zone is greater than the first target temperature corresponding to the second time-temperature relationship zone; and the first target temperature corresponding to the second time-temperature relationship zone is greater than the first target temperature corresponding to the third time-temperature relationship zone.

Further, in the aerosol generating device of the present disclosure, the first target temperature corresponding to the first time-temperature relationship zone ranges from 900° C. to 1200° C.;
the first target temperature corresponding to the second time-temperature relationship zone ranges from 600° C. to 900° C.; and
the first target temperature corresponding to the third time-temperature relationship zone ranges from 500° C. to 700° C.

Further, in the aerosol generating device of the present disclosure, the preset time-temperature relationship includes three time-temperature relationship zones: a first time-temperature relationship zone, a second time-temperature relationship zone, and a third time-temperature relationship zone.

The duration of the first time-temperature relationship zone is less than the duration of the second time-temperature relationship zone, and the duration of the first time-temperature relationship zone is less than the duration of the third time-temperature relationship zone.

Further, in the aerosol generating device of the present disclosure, the duration of the first time-temperature relationship zone is 0 second to 40 seconds; the duration of the second time-temperature relationship zone is 40 seconds to 200 seconds; and the duration of the third time-temperature relationship zone is 200 seconds to 360 seconds.

Further, in the aerosol generating device of the present disclosure, the heating element is located inside the housing; the heating element includes a heating base and an infrared radiation layer wrapped around the heating base; the heating element is configured to excite, after being powered on, the infrared radiation layer to generate the infrared light; and the housing is at least partially configured to be inserted into an aerosol generating substrate.

Further, in the aerosol generating device of the present disclosure, the housing includes an outer shell and an inner shell; the inner shell is located inside the outer shell; the heating element is located between the outer shell and the inner shell; the heating element includes a heating base and an infrared radiation layer wrapped around the heating base; the heating element is configured to excite, after being powered on, the infrared radiation layer to generate the infrared light; the inner shell allows the infrared light to pass through; and the inner shell forms an accommodating cavity for accommodating an aerosol generating substrate.

Further, in the aerosol generating device of the present disclosure, the control unit is further configured to record one user puff when a sudden decrease in the housing wall temperature is monitored; and the sudden decrease refers to a case where a decrease value of the housing wall temperature within a preset time period is greater than a preset decrease value or a decrease amplitude of the housing wall temperature within a preset time period is greater than a preset decrease amplitude.

Further, in the aerosol generating device of the present disclosure, the control unit searches for a first target temperature corresponding to a current puff count based on a correspondence relationship between a puff count and the first target temperature.

In addition, the present disclosure further provides a temperature control method for an aerosol generating device. The device includes a heating element and a housing; the heating element and the housing wall of the housing are at least partially spaced apart; the heating element is powered on to generate infrared light; the housing wall of the housing allows the infrared light to pass through; and the method includes the following steps:
obtaining the housing wall temperature of the housing wall;
obtaining a preset temperature, and outputting a target control temperature based on the preset temperature and the housing wall temperature; and
obtaining the heating element temperature of the heating element; and
outputting the target control temperature based on the preset temperature and the housing wall temperature, processing the heating element temperature and the target control temperature by using a preset algorithm, and adjusting power supplying of the heating element.

The aerosol generating device and the temperature control method therefor for implementing the present disclosure have the following beneficial effects: The present disclosure heats the aerosol generating substrate in two manners: conduction and heat radiation, and adjusts the power supplying of the heating element based on a temperature feedback, so that the heating in an entire heating stage is more sufficient, and the heating is more stable.

To provide a clearer understanding of the technical features, objectives, and effects of the present disclosure, specific implementations of the present disclosure are described in detail with reference to the accompanying drawings.

In a preferred embodiment, an aerosol generating device of this embodiment includes a heating element and a housing. The heating element and the housing wall of the housing are at least partially spaced apart. That is, the heating element and the housing wall are not in direct contact. For example, the heating element and the housing wall are isolated by gas. Since the heating element and the housing wall are not in direct contact, heat transferred by the heating element to the housing wall in a manner of conduction is limited. As a result, the temperature of the housing wall may be usually less than the temperature of the heating element. However, some heat is still transferred to the housing wall in the manner of conduction. The housing wall then transfers the heat to the aerosol generating substrate, so as to heat the aerosol generating substrate in the manner of conduction.

The heating element is configured to generate infrared light. In some implementations, that the heating element is powered on to excite an infrared radiation layer to radiate the infrared light may be implemented by covering the surface of the heating element with the infrared radiation layer. A principle of infrared radiation is not elaborated herein again. It may be understood that a function of the infrared radiation layer for radiating the infrared light is to heat the aerosol generating substrate, and the wavelength of the infrared light needs to match the aerosol generating substrate, so that the requirement is to be met during selection of a material of the infrared radiation layer. Certainly, different infrared radiation layers may alternatively be selected based on different aerosol generating substrates to achieve a best radiation heating effect. The infrared light generated by the infrared radiation layer is irradiated onto the aerosol generating substrate through the housing wall, to heat the aerosol generating substrate. It may be understood that compared with a conduction heating manner, the infrared light radiation heating manner has particular penetrability, and can more uniformly heat the aerosol generating substrate. If the aerosol generating substrate is heated more uniformly, a generated aerosol will be more stable.

In some embodiments, the heating element includes a heating base and an infrared radiation layer wrapped around the heating base. The heating base includes a metal base with high-temperature oxidation resistance, for example, a metal wire. The heating base may be a metal material that has good high-temperature oxidation resistance, high stability, difficult deformation, and the like, such as a nichrome base (such as a nichrome wire) and an aludirome base (such as an aludirome wire). In some embodiments, a diameter of the metal wire may be 0.15 mm to 0.8 mm, that is, the diameter of the metal wire may be 0.15 mm, or 0.8 mm, or any value between 0.15 mm and 0.8 mm. The metal wire may be bent or wound into various shapes, such as a spiral shape, a mesh shape, an M shape, or an N shape. The entire bent or wound heating element has a columnar shape, a spiral segment, a mesh shape, or other three-dimensional or planar shape with bends.

In this embodiment, the heating element further includes an oxidation resistance layer, and the oxidation resistance layer is formed between the heating base and the infrared radiation layer. Specifically, the oxidation resistance layer may be an oxide film. The heating base is subjected to high-temperature heat treatment, and a dense oxide film is formed on the surface of the heating base. The oxide film forms the oxidation resistance layer. Certainly, it may be understood that in some other embodiments, the oxidation resistance layer is not limited to including the oxide film formed by itself. In some other embodiments, the oxidation resistance layer may be an oxidation resistance coating applied to the outer surface of the heating base. The thickness of the oxidation resistance layer may be selected to be 1 μm to 150 μm, that is, the thickness of the oxidation resistance layer may be selected to be 1 μm, or 150 μm, or any value between 1 μm and 150 μm.

In this embodiment, the infrared radiation layer may be an infrared layer. The infrared layer may be formed on one side of the oxidation resistance layer away from the heating base by an infrared layer forming base through high-temperature heat treatment. Specifically, the infrared layer forming base may be silicon carbide, spinel, or a composite base thereof. Certainly, it may be understood that in some other embodiments, the infrared radiation layer is not limited to being the infrared layer. In some other embodiments, the infrared radiation layer may be a composite infrared layer. Specifically, the infrared layer may be formed on the side of the oxidation resistance layer away from the heating base in a manner of dip coating, spray coating, brush coating, or the like. The thickness of the infrared radiation layer may be 10 μm to 300 μm, that is, the thickness of the infrared radiation layer may be 10 μm, or 300 μm, or any value between 10 μm and 300 μm.

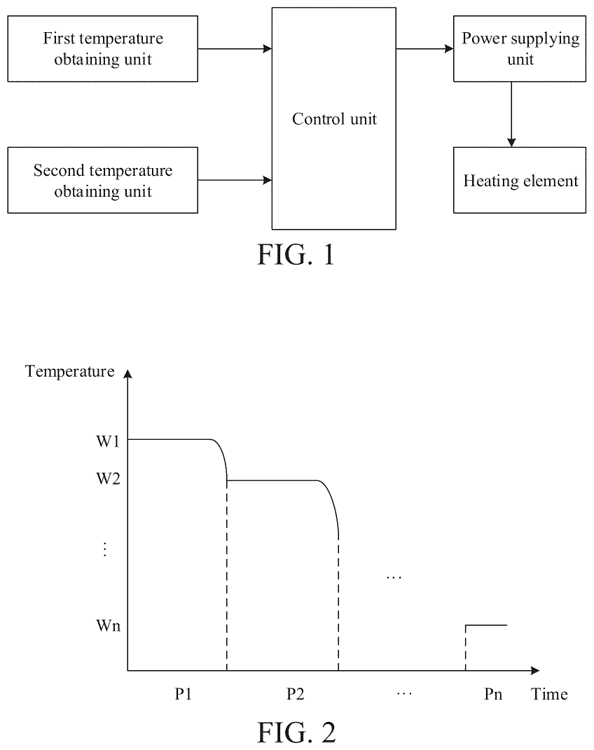

Referring to FIG. 1, the aerosol generating device of this embodiment further includes a first temperature obtaining unit, a second temperature obtaining unit, and a control unit. The control unit is separately connected to the first temperature obtaining unit and the second temperature obtaining unit.

The first temperature obtaining unit is configured to: obtain the housing wall temperature of the housing wall and transmit the obtained housing wall temperature to the control unit. The housing wall temperature is configured to describe a current heat state of the housing wall, so as to better control the amount of heat transferred to the aerosol generating substrate in the conduction manner. Since the housing wall temperature is configured to describe the current heat state of the housing wall, the housing wall temperature may be described by selecting a plurality of angles, and may be a temperature of the outer side of the housing wall, a temperature of the inner side of the housing wall, a temperature of a region near the housing wall, or the like. After different angles are selected for selection, correction and conversion are performed based on differences between the temperatures at the angles and the true temperature of the housing wall. For example, the temperature of the region near the housing wall is selected as the housing wall temperature. Since the temperature of the region near the housing wall may be less than the true temperature of the housing wall in some cases, the temperature of the region near the housing wall needs to be corrected for a particular amount, so as to obtain the housing wall temperature that can accurately describe the current heat state of the housing wall. Optionally, the first temperature obtaining unit may use a temperature sensor, a temperature measurement film, a thermocouple, a thermistor, or the like, or may use another temperature measurement technology. This is not limited in this embodiment.

The second temperature obtaining unit is configured to: obtain the heating element temperature of the heating element, and transmit the obtained heating element temperature to the control unit. The heating element temperature is configured to describe a current heat state of the heating element, to control the infrared light radiated by the infrared radiation layer, and certainly may synchronously affect the amount of heat transferred by the heating element to the housing wall in the conduction manner. During the measurement of the heating element temperature, temperature measurement can be directly performed on different parts of the heating element. For example, the temperature of a center part or an edge part of the heating element is measured, and the temperatures of different regions are used as the true temperature of the heating element after being corrected and converted. Or, a temperature measurement element that is connected in series with the heating element may be selected to indirectly measure the temperature. Optionally, the second temperature obtaining unit may use a temperature sensor, a temperature measurement film, a thermocouple, a thermistor, or the like, or may use another temperature measurement technology. This is not limited in this embodiment.

The control unit receives the housing wall temperature and the heating element temperature. A target control temperature is first output based on a preset temperature and the housing wall temperature. The target control temperature is a target temperature adjusted for the heating element, that is, a temperature that the heating element reaches after adjustment. Then, the control unit processes the heating element temperature and the target control temperature by using a preset algorithm, for example, processes the heating element temperature and the target control temperature by using a proportion-integration-differentiation (PID) control algorithm, a fuzzy control algorithm, or an object control algorithm, and generates a control instruction for controlling a power supplying unit to output power supplying, thus adjusting the power supplying of the heating element and enabling the housing wall temperature to reach the preset temperature after the power supplying of the heating element is adjusted. Therefore, the heating of the aerosol generating device is more sufficient, and the heating amount is more stable.

In this embodiment, the aerosol generating substrate is heated in two manners: conduction and heat radiation, so that the aerosol generating substrate is heated more uniformly. The power supplying of the heating element is adjusted by monitoring the housing wall temperature, so that both the housing wall temperature and the heating element temperature are maintained at preset optimal states. Thus, the heating in an entire heating stage is more sufficient, and the heating amount is more stable.

In the aerosol generating device of some embodiments, the control unit processes the heating element temperature and the target control temperature based on the PID control algorithm, to adjust the power supplying of the heating element. The target control temperature is a target temperature adjusted by the heating element, and includes a first target temperature and a second target temperature. Specifically, after receiving the housing wall temperature, the control unit compares the housing wall temperature with the preset temperature, outputs the first target temperature when the housing wall temperature is less than the preset temperature, and outputs the second target temperature when the housing wall temperature is not less than the preset temperature. The first target temperature is a temperature at which the heating element can radiate the infrared light and the infrared light has a suitable wavelength for heating the aerosol generating substrate. The so-called “temperature suitable for heating the aerosol generating substrate” means that the aerosol generating substrate has a best or better heating effect at this temperature. It may be understood that different aerosol generating substrates correspond to different suitable temperatures, and the suitable temperatures need to be adaptively selected based on the aerosol generating substrates. In some embodiments, the temperature suitable for heating the aerosol generating substrate is 500° C. to 1200° C. Optionally, a value range of the “temperature suitable for heating the aerosol generating substrate” is a value range of the first target temperature. The second target temperature is not greater than the natural temperature of the heating element without power supplying, and the first target temperature is greater than the second target temperature. It should be noted that the natural temperature of the heating element without power supplying is the temperature of the heating element when the heating element is not heated, or may be understood as the temperature of the heating element that is in the natural state alone, but does not include a temperature at which the heating element has not been cooled to the natural temperature state within a heating suspension period after the heating element is heated. For example, when the housing wall temperature is 240° C., and the preset temperature of the housing wall is 250° C. In this case, the housing wall temperature is less than the preset temperature, so that the heating element temperature needs to be increased, to increase the radiation amount of the infrared light. Thus, the housing wall temperature is increased to the preset temperature. Therefore, in this case, the target temperature adjusted for the heating element is set to be the first target temperature. For another example, when the housing wall temperature is 260° C., and the preset temperature of the housing wall is 250° C. In this case, the housing wall temperature is greater than the preset temperature, so that the heating element temperature needs to be decreased, to decrease the radiation amount of the infrared light. Thus, the housing wall temperature is decreased to the preset temperature. Therefore, in this case, the target temperature adjusted for the heating element is set to be the second target temperature. A purpose of such setting is to control the heating element temperature to be within a temperature range in which the infrared light is generated, thereby increasing a proportion of the radiation effect to the heating of the aerosol generating substrate.

Further, in consideration of differences in working conditions of the aerosol generating device in working stages such as a preheating stage and a puff stage, in this embodiment, the preset temperature is a time-varying variable. The control unit starts timing after starting to heat the heating element, and obtains a preset temperature corresponding to current time based on a preset time-temperature relationship. The preset time-temperature relationship is a correspondence relationship between time and a preset temperature, and the preset time-temperature relationship is stored in a storage unit of the aerosol generating device.

Optionally, the preset time-temperature relationship is divided into at least two time-temperature relationship zones in chronological order. A relationship corresponding to a period of time in the preset time-temperature relationship is a time-temperature relationship zone. The time-temperature relationship zone is divided in chronological order, starting from the beginning of timing. Two adjacent time-temperature relationship zones are consecutive in time, but have no repeated part in time. That is, the preset time-temperature relationship is segmented into at least two time-temperature relationship zones (a first temperature relationship zone and a second temperature relationship zone). It should be noted that a change trend of the preset temperature may be considered during the division of the time-temperature relationship zones, and parts with change trends that are consistent or with preset temperatures that are the same or similar are classified into the same time-temperature relationship zone.

Further, the temperature of the preset time-temperature relationship decreases in sequence along with each time-temperature relationship. That is, all the time-temperature relationship zones are arranged in chronological order. The temperature of the preset time-temperature relationship decreases in sequence along with each time-temperature relationship zone. Preferably, each time-temperature relationship zone corresponds to one temperature value, and the temperature of the preset time-temperature relationship stepwise decreases in sequence along with each time-temperature relationship zone. For example, the first temperature relationship zone is usually a region corresponding to the preheating stage, and the second temperature relationship zone is a region corresponding to the puff stage. The temperature in the preheating stage is greater than the temperature in the puff stage. As shown in FIG. 2, the preset time-temperature relationship in the figure is divided into at least two time-temperature relationship zones, which are respectively a time-temperature relationship zone P1, a time-temperature relationship zone P2, . . . , a time-temperature relationship zone Pn, and the like, where n is an integer greater than 1. The temperatures corresponding to the time-temperature relationship zone P1, the time-temperature relationship zone P2, . . . , and the time-temperature relationship zone Pn are respectively W1, W2, . . . , and Wn. It can be seen from the figure that W1, W2, . . . , and Wn decrease in sequence along with P1, P2, . . . , and Pn. In some embodiments, infrared lights generated by the heating element have different wavelengths within different temperature ranges. The higher temperature of the heating element indicates the shorter wavelength of the generated infrared light, and the shorter wavelength indicates the relatively reduced infrared light penetrability. All the time-temperature relationship zones are arranged in chronological order, and each time-temperature relationship zone corresponds to one first target temperature. The first target temperature decreases in sequence along with each time-temperature relationship zone, so as to control infrared radiation bands radiated by the heating element, thereby controlling the radiation amount and facilitating matching of the aerosol generating substrate. Specifically, the first target temperature corresponding to the first time-temperature relationship zone ranges from 900° C. to 1200° C., that is, the first target temperature corresponding to the first time-temperature relationship zone may be 900° C., 1200° C., or any value between 900° C. and 1200° C. The first target temperature corresponding to the second time-temperature relationship zone ranges from 600° C. to 900° C., that is, the first target temperature corresponding to the second time-temperature relationship zone may be 600° C., 900° C., or any value between 600° C. and 900° C. The first target temperature corresponding to the third time-temperature relationship zone ranges from 500° C. to 700° C., that is, the first target temperature corresponding to the third time-temperature relationship zone may be 500° C., 700° C., or any value between 500° C. and 700° C.

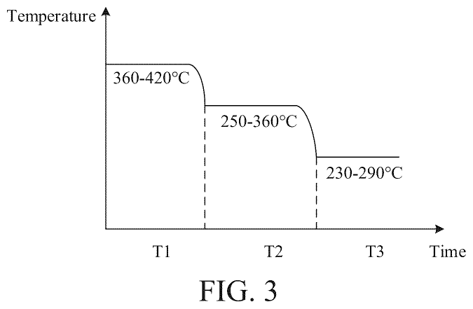

In the aerosol generating device of some embodiments, referring to FIG. 3, the preset time-temperature relationship includes three time-temperature relationship zones: a first time-temperature relationship zone, a second time-temperature relationship zone, and a third time-temperature relationship zone. The first time-temperature relationship zone is denoted as T1, the second time-temperature relationship zone is denoted as T2, and the third time-temperature relationship zone is denoted as T3.

Further, the preset temperature corresponding to the first time-temperature relationship zone is greater than the preset temperature corresponding to the second time-temperature relationship zone, and the preset temperature corresponding to the second time-temperature relationship zone is greater than the preset temperature corresponding to the third time-temperature relationship zone. Optionally, the preset temperature corresponding to the first time-temperature relationship zone ranges from 360° C. to 420° C., that is, the preset temperature corresponding to the first time-temperature relationship zone may be 360° C., 420° C., or any value between 360° C. and 420° C. The preset temperature corresponding to the second time-temperature relationship zone ranges from 250° C. to 360° C., that is, the preset temperature corresponding to the second time-temperature relationship zone may be 250° C., 360° C., or any value between 250° C. and 360° C. The preset temperature corresponding to the third time-temperature relationship zone ranges from 230° C. to 290° C., that is, the preset temperature corresponding to the third time-temperature relationship zone may be 230° C., 290° C., or any value between 230° C. and 290° C. In some embodiments, in the puff stage (a time period corresponding to the second time-temperature relationship zone and the third time-temperature relationship zone), effective components of the aerosol generating substrate gradually decrease with puff time, and the amount of heat required for the pyrolysis of the effective components also gradually decrease. The temperature corresponding to the third time-temperature relationship zone is set to be less than the temperature corresponding to the second time-temperature relationship zone, to ensure that the aerosol generating substrate does not generate a burnt smelt and a peculiar smell. It may be understood that the ranges of the preset temperatures and the first target temperatures that correspond to the first time-temperature relationship zone, the second time-temperature relationship zone, and the third time-temperature relationship zone are value ranges. In a specific implementation process, only one of the values needs to be selected as the preset temperature or only one of the values needs to be selected as the first target temperature.

In the aerosol generating device of some embodiments, the second target temperature ranges from 0° C. to 30° C. It may be understood that the second target temperature may be flexibly adjusted based on a use environment of the aerosol generating device, and the range of the second target temperature at the natural temperature falls within the inventive concept of this embodiment.

In the aerosol generating device of some embodiments, the preset time-temperature relationship includes three time-temperature relationship zones: a first time-temperature relationship zone, a second time-temperature relationship zone, and a third time-temperature relationship zone. It may be understood that since the heating element temperature in the first time-temperature relationship zone is high, the energy of the heating element that radiates the infrared light per unit time is high (i.e. the radiation power is high). Therefore, the heating duration is relatively short. Similarly, since the heating element temperature decreases in the second time-temperature relationship zone and the third time-temperature relationship zone, the energy of the heating element that radiates the infrared light per unit time decreases (i.e. the radiation power is low). Therefore, the heating duration is relatively long. Optionally, the duration of the first time-temperature relationship zone is less than the duration of the second time-temperature relationship zone, and the duration of the first time-temperature relationship zone is less than the duration of the third time-temperature relationship zone. For example, if one work cycle is 360 seconds, the duration of the first time-temperature relationship zone is 0 second to 40 seconds, the duration of the second time-temperature relationship zone is 40 second to 200 seconds, and the duration of the third time-temperature relationship zone is 200 second to 360 seconds. That is, within the work cycle of 360 seconds, starting from the beginning of timing, the duration of 0 second to 40 seconds is used as the first time-temperature relationship zone; the duration of 40 seconds to 200 seconds is used as the second time-temperature relationship zone; and the duration of 200 seconds to 360 seconds is used as the third time-temperature relationship zone. The examples herein are merely used for describing the principle of dividing the first time-temperature relationship zone, the second time-temperature relationship zone, and the third time-temperature relationship zone, and adaptability adjustment may be performed based on an actual application scenario under the technical concept of this embodiment.

In the aerosol generating device of some embodiments, the control unit is further configured to: monitor whether a sudden decrease occurs in the housing wall temperature, and record one user puff when a sudden decrease in the housing wall temperature is monitored. The sudden decrease refers to a case where a decrease value of the housing wall temperature within a preset time period is greater than a preset decrease value or a decrease amplitude of the housing wall temperature within a preset time period is greater than a preset decrease amplitude. The decrease amplitude is a decrease amplitude. The preset decrease amplitude is a decrease amplitude set in advance. The preset decrease amplitude is a value that is set in advance and is configured to evaluate a change trend of the housing wall temperature. The decrease amplitude may be defined as a percentage of a decrease value of the temperature of a current moment relative to a previous moment to the temperature of the previous moment. For example, the temperature of the previous moment is 300° C., and the current temperature is 270° C. Thus, the decrease value of the temperature of the current moment relative to the previous moment is 30° C., and the decrease amplitude is 10%. It may be understood that when a user takes a puff, a large number of aerosols may be rapidly generated, heat of the housing wall may be rapidly consumed. Meanwhile, a large amount of cold air is brought in to absorb the heat of the housing wall. Therefore, this process can rapidly reduce the heat of the housing wall and rapidly reduce the housing wall temperature of the housing wall within short time. In this embodiment, a puff count of a user is detected by monitoring the sudden change in the housing wall temperature, and no additional control hardware is required, thereby implementing counting of the puff count without increasing the costs.

In the aerosol generating device of some embodiments, the aerosol generating device further includes a storage unit configured to store a correspondence relationship between a puff count and a first target temperature. Usually, the aerosol generating device has an approximate puff count in a work cycle. For example, one unit of the aerosol generating substrate has 12 puffs to 16 puffs. After a new work cycle starts, the control unit counts a puff count within this cycle, searches for a first target temperature corresponding to a current puff count based on the correspondence relationship between the puff count and the first target temperature, and uses the obtained first target temperature to the control process of the above embodiment.

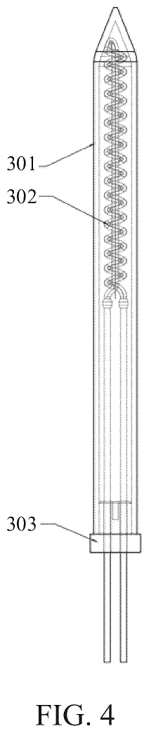

In a preferred embodiment, referring to FIG. 4, a heating element 302 is located inside a housing 301. The housing 301 and the heating element 302 are mounted on a base 303, and the housing 301 is at least partially inserted into the aerosol generating substrate. The heating element 302 and the wall portion of the housing 301 are at least partially spaced apart. The surface of the heating element 302 is covered with an infrared radiation layer. The heating element 302 is powered on to excite the infrared radiation layer to radiate infrared light. The heating element 302 radiates the infrared light through the housing 301 to heat an aerosol generating substrate located outside the housing 301.

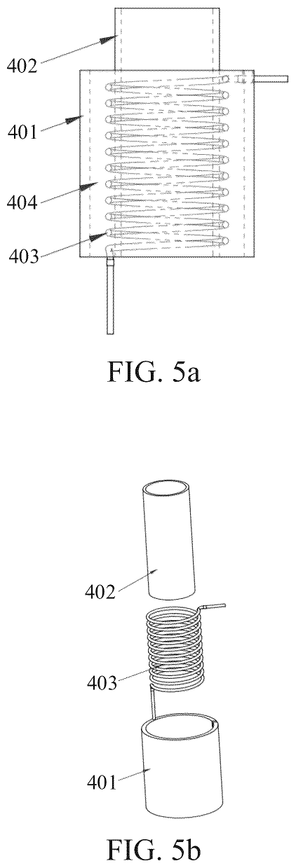

In a preferred embodiment, referring to FIG. 5a and FIG. 5b, schematic structural diagrams corresponding to another embodiment according to the present disclosure are shown. Specifically, the housing includes an outer shell 401 and an inner shell 402. The inner shell 402 is located inside the outer shell 401. A gap is reserved between the outer shell 401 and the inner shell 402. The gap between the outer shell 401 and the inner shell 402 forms a first accommodating cavity. The first accommodating cavity is configured to accommodate a heating element 403. That is, the heating element 403 is located between the outer shell 401 and the inner shell 402, and the heating element 403 surrounds the inner shell 402 by one circle. A second accommodating cavity is formed inside the inner shell 402, and the second accommodating cavity is configured to place an aerosol generating substrate. The heating element 403 is powered on to excite an infrared radiation layer to radiate infrared light, and the inner shell 402 allows the infrared light to pass through, to heat the aerosol generating substrate. 404 represents a gap between the heating element 403 and the outer shell 401. Optionally, the outer shell 401 and the inner shell 402 are columnar, for example, cylindrical.

Optionally, the heating element may be of a single-spiral, double-spiral, or N-shaped structure formed by winding a heating wire, or may be barrel-shaped, sheet-like, or columnar.

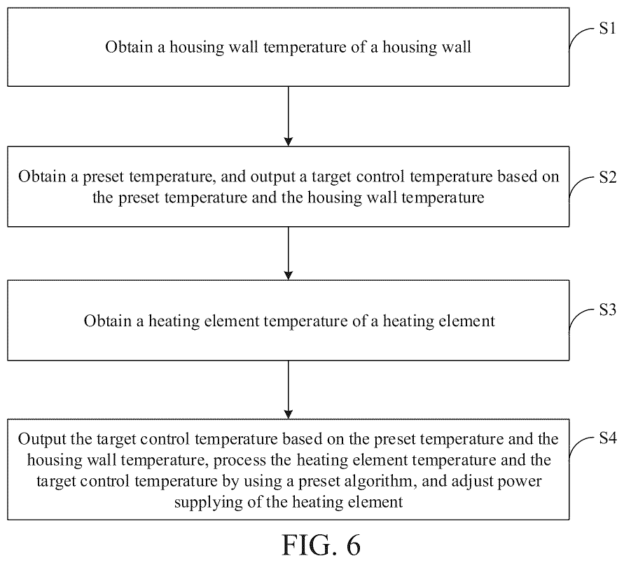

Specifically, as shown in FIG. 6, a temperature control method for the aerosol generating device includes the following steps:

Step S1. Obtain the housing wall temperature of the housing wall.

Specifically, the first temperature obtaining unit of the aerosol generating device is configured to: obtain the housing wall temperature of the housing wall and transmit the obtained housing wall temperature to the control unit. The housing wall temperature is configured to describe a current heat state of the housing wall, so as to better control the amount of heat transferred to the aerosol generating substrate in the conduction manner. Since the housing wall temperature is configured to describe the current heat state of the housing wall, the housing wall temperature may be described by selecting a plurality of angles, and may be a temperature of the outer side of the housing wall, a temperature of the inner side of the housing wall, a temperature of a region near the housing wall, or the like. After different angles are selected for selection, correction and conversion are performed based on differences between the temperatures at the angles and the true temperature of the housing wall. For example, the temperature of the region near the housing wall is selected as the housing wall temperature. Since the temperature of the region near the housing wall may be less than the true temperature of the housing wall, the temperature of the region near the housing wall needs to be corrected for a particular amount, so as to obtain the housing wall temperature that can accurately describe the current heat state of the housing wall. Optionally, the first temperature obtaining unit may use a temperature sensor, a temperature measurement film, a thermocouple, a thermistor, or the like, or may use another temperature measurement technology. This is not limited in this embodiment.

Step S2. Obtain a preset temperature, and output a target control temperature based on the preset temperature and the housing wall temperature.

Specifically, after receiving the housing wall temperature, the control unit of the aerosol generating device outputs the target control temperature based on the preset temperature and the housing wall temperature. The target control temperature is a target temperature adjusted for the heating element, that is, a temperature that the heating element reaches after adjustment.

Step S3. Obtain the heating element temperature of the heating element.

Specifically, the second temperature obtaining unit of the aerosol generating device is configured to: obtain the heating element temperature of the heating element, and transmit the obtained heating element temperature to the control unit. The heating element temperature is configured to describe a current heat state of the heating element, to control the infrared light radiated by the infrared radiation layer, and certainly may synchronously affect the amount of heat transferred by the heating element to the housing wall in the conduction manner. During the measurement of the heating element temperature, temperature measurement can be directly performed on different parts of the heating element. For example, the temperature of a center part or an edge part of the heating element is measured, and the temperatures of different regions are used as the true temperature of the heating element after being corrected and converted. Or, a temperature measurement element that is connected in series with the heating element may be selected to indirectly measure the temperature. Optionally, the second temperature obtaining unit may use a temperature sensor, a temperature measurement film, a thermocouple, a thermistor, or the like, or may use another temperature measurement technology. This is not limited in this embodiment.

Step S4. Output the target control temperature based on the preset temperature and the housing wall temperature, process the heating element temperature and the target control temperature by using a preset algorithm, and adjust power supplying of the heating element.

Specifically, the control unit of the aerosol generating device processes the heating element temperature and the target control temperature by using the preset algorithm, for example, processes the heating element temperature and the target control temperature by using a PID control algorithm, and generates a control instruction for controlling a power supplying unit to output power supplying, thus adjusting the power supplying of the heating element and enabling the heating element to reach the target control temperature after the power supplying is adjusted. Therefore, the heating of the aerosol generating device is more sufficient, and the heating amount is more stable.

In this embodiment, the aerosol generating substrate is heated in two manners: conduction and heat radiation, so that the aerosol generating substrate is heated more uniformly. The power supplying of the heating element is adjusted by monitoring the housing wall temperature and the heating element temperature, so that both the housing wall temperature and the heating element temperature are maintained at preset optimal states. Thus, the heating in an entire heating stage is more sufficient, and the heating amount is more stable.

In a preferred embodiment, the aerosol generating device of this embodiment includes a memory and a processor. The memory has a computer program stored therein. The processor performs the steps of the temperature control method for the aerosol generating device of the foregoing embodiments by invoking the computer program stored in the memory.

The embodiments in this specification are all described in a progressive manner. For description of each of the embodiments focuses on differences from other embodiments, refer to each other for the same or similar parts among the embodiments. Since the apparatus disclosed in the embodiments correspond to the method disclosed in the embodiments, the apparatus is described simply, and related parts are found in some of the explanations of the method.

A person skilled in the art may further realize that units and algorithm steps of all the examples described in the foregoing embodiments disclosed herein may be implemented by electronic hardware, computer software, or a combination thereof. To clearly describe the interchangeability between the hardware and the software, the foregoing has generally described compositions and steps of each example based on functions. Whether the functions are executed in a mode of hardware or software depends on particular applications and design constraint conditions of the technical solutions. A person skilled in the art can use different methods to implement the described functions for each particular application, but it should not be considered that the implementation goes beyond the scope of the embodiments of the present disclosure.

The steps of the method or algorithm described in conjunction with the embodiments disclosed herein can be implemented directly using hardware, software modules executed by the processor, or a combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol generating device, comprising:
a heating element configured to generate infrared light;
a housing having a housing wall configured to allow the infrared light to pass through, the heating element and the housing wall being at least partially spaced apart;
a first temperature obtaining unit configured to obtain the housing wall temperature of the housing wall;
a second temperature obtaining unit configured to obtain the heating element temperature of the heating element; and
a control unit configured to:
output a target control temperature based on a preset temperature and the housing wall temperature,
process the heating element temperature and the target control temperature using a preset algorithm, and
adjust power supplying of the heating element.

2. The aerosol generating device of claim 1, wherein the control unit is configured to output a first target temperature when the housing wall temperature is less than the preset temperature and output a second target temperature when the housing wall temperature is not less than the preset temperature, the first target temperature being greater than the second target temperature,
wherein the control unit is configured to process the heating element temperature and the target control temperature using a proportion-integration-differentiation (PID) control algorithm and to adjust the power supplying of the heating element, and
wherein the target control temperature comprises the first target temperature and the second target temperature.

3. The aerosol generating device of claim 2, wherein the first target temperature is a temperature at which the heating element radiates the infrared light and the wavelength of the infrared light heats an aerosol generating substrate.

4. The aerosol generating device of claim 2, wherein the second target temperature is not greater than a natural temperature of the heating element without power supplying.

5. The aerosol generating device of claim 2, wherein the second target temperature ranges from 0° C. to 30° C.

6. The aerosol generating device of claim 2, wherein the control unit is configured to obtain a preset temperature corresponding to current time based on a preset time-temperature relationship, and
wherein the preset time-temperature relationship comprises a correspondence relationship between time and a preset temperature.

7. The aerosol generating device of claim 6, wherein the preset time-temperature relationship is divided into at least two time-temperature relationship zones in chronological order, the temperature of the preset time-temperature relationship decreasing in sequence along with each time-temperature relationship zone, and
wherein each time-temperature relationship zone corresponds to one first target temperature, and
wherein the first target temperature decreases in sequence along with each time-temperature relationship zone.

8. The aerosol generating device of claim 7, wherein the preset time-temperature relationship comprises three time-temperature relationship zones, including: a first time-temperature relationship zone, a second time-temperature relationship zone, and a third time-temperature relationship zone, and
wherein the preset temperature corresponding to the first time-temperature relationship zone is greater than the preset temperature corresponding to the second time-temperature relationship zone and
wherein the preset temperature corresponding to the second time-temperature relationship zone is greater than the preset temperature corresponding to the third time-temperature relationship zone.

9. The aerosol generating device of claim 8, wherein the preset temperature corresponding to the first time-temperature relationship zone ranges from 360° C. to 420° C.,
wherein the preset temperature corresponding to the second time-temperature relationship zone ranges from 250° C. to 360° C., and
wherein the preset temperature corresponding to the third time-temperature relationship zone ranges from 230° C. to 290° C.

10. The aerosol generating device of claim 7, wherein the preset time-temperature relationship comprises three time-temperature relationship zones, including: a first time-temperature relationship zone, a second time-temperature relationship zone, and a third time-temperature relationship zone, and
wherein the first target temperature corresponding to the first time-temperature relationship zone is greater than the first target temperature corresponding to the second time-temperature relationship zone, and
wherein the first target temperature corresponding to the second time-temperature relationship zone is greater than the first target temperature corresponding to the third time-temperature relationship zone.

11. The aerosol generating device of claim 10, wherein the first target temperature corresponding to the first time-temperature relationship zone ranges from 900° C. to 1200° C.,
wherein the first target temperature corresponding to the second time-temperature relationship zone ranges from 600° C. to 900° C., and
wherein the first target temperature corresponding to the third time-temperature relationship zone ranges from 500° C. to 700° C.

12. The aerosol generating device of claim 7, wherein the preset time-temperature relationship comprises three time-temperature relationship zones, including: a first time-temperature relationship zone, a second time-temperature relationship zone, and a third time-temperature relationship zone, and
wherein a duration of the first time-temperature relationship zone is less than a duration of the second time-temperature relationship zone, and
wherein a duration of the first time-temperature relationship zone is less than a duration of the third time-temperature relationship zone.

13. The aerosol generating device of claim 12, wherein the duration of the first time-temperature relationship zone is 0 second to 40 seconds,
wherein the duration of the second time-temperature relationship zone is 40 seconds to 200 seconds, and
wherein the duration of the third time-temperature relationship zone is 200 seconds to 360 seconds.

14. The aerosol generating device of claim 1, wherein the heating element is located inside the housing,
wherein the heating element comprises a heating base and an infrared radiation layer wrapped around the heating base,
wherein the heating element is configured to excite, after being powered on, the infrared radiation layer to generate the infrared light, and
wherein the housing is at least partially insertable into an aerosol generating substrate.

15. The aerosol generating device of claim 1, wherein the housing comprises an outer shell and an inner shell,
wherein the inner shell is located inside the outer shell,
wherein the heating element is located between the outer shell and the inner shell,
wherein the heating element comprises a heating base and an infrared radiation layer wrapped around the heating base,
wherein the heating element is configured to excite, after being powered on, the infrared radiation layer so as to generate the infrared light,
wherein the inner shell allows the infrared light to pass through, and
wherein the inner shell forms an accommodating cavity configured to accommodate an aerosol generating substrate.

16. The aerosol generating device of claim 2, wherein the control unit is configured to record one user puff upon monitoring a sudden decrease in the housing wall temperature, and
wherein the sudden decrease comprises a decrease value of the housing wall temperature within a preset time period being greater than a preset decrease value, or a decrease amplitude of the housing wall temperature within a preset time period being greater than a preset decrease amplitude.

17. The aerosol generating device of claim 16, wherein the control unit is configured to search for a first target temperature corresponding to a current puff count based on a correspondence relationship between a puff count and a first target temperature.

18. A temperature control method for an aerosol generating device, comprising:
providing a heating element and a housing, the heating element and a housing wall of the housing being at least partially spaced apart, the heating element being powered on to generate infrared light, the housing wall of the housing being configured to allow the infrared light to pass through;
obtaining a housing wall temperature of the housing wall;
obtaining a preset temperature;
obtaining the heating element temperature of the heating element;
outputting a target control temperature based on the preset temperature and the housing wall temperature;
processing the heating element temperature and the target control temperature using a preset algorithm; and
adjusting power supplying of the heating element.

19. A computer storage medium, storing therein a computer program, which, when executed by a processor, implements the temperature control method of claim 18.

20. A method for controlling a temperature of an aerosol generating device, the method comprising:
providing the aerosol generating device, the aerosol generating device comprising:
a heating element configured to generate infrared light;
a housing having a housing wall configured to allow the infrared light to pass through, the heating element and the housing wall being at least partially spaced apart;
a first temperature obtaining unit configured to obtain the housing wall temperature of the housing wall;
a second temperature obtaining unit configured to obtain the heating element temperature of the heating element; and
a control unit;
outputting, with the control unit, a first target temperature when the housing wall temperature is less than the preset temperature, and outputting a second target temperature when the housing wall temperature is not less than the preset temperature, the first target temperature being greater than the second target temperature,
processing, with the control unit, the heating element temperature and the target control temperature using a proportion-integration-differentiation (PID) control algorithm; and
adjusting, with the control unit, a power supplying of the heating element,
wherein the target control temperature comprises the first target temperature and the second target temperature.
